(19) United States
(12) Patent Application Publication
(10) Pub. No.: US 2019/0172106 A1
(43) Pub. Date: Jun. 6, 2019

(54) RENTAL FEE SETTING APPARATUS, RENTAL FEE NOTIFICATION METHOD, AND RENTAL FEE SETTING SYSTEM

(71) Applicant: TOYOTA JIDOSHA KABUSHIKI KAISHA, Toyota-shi (JP)

(72) Inventors: Hiroshi IGATA, Yokohama-shi (JP); Shin SAKURADA, Toyota-shi (JP); Kuniaki JINNAI, Nagoya-shi (JP); Motoyoshi HATTA, Anjo-shi (JP); Shota HIROSE, Toyoake-shi (JP)

(73) Assignee: TOYOTA JIDOSHA KABUSHIKI KAISHA, Toyota-shi (JP)

(21) Appl. No.: 16/210,611

(22) Filed: Dec. 5, 2018

(30) Foreign Application Priority Data
Dec. 6, 2017 (JP) 2017-234440

(51) Int. Cl. G06Q 30/02; G06Q 30/06; G06Q 10/02; G06Q 50/30

(52) U.S. Cl. CPC G06Q 30/0283; G06Q 30/0645; B60L 11/1848; G06Q 50/30; G06Q 10/02

(57) ABSTRACT

When a management server receives a request for reservation cancellation, the management server performs a process including: a step of specifying a user and obtaining reservation information; a step of adding “1” to the number of cancellations having a large degree of influence when a period until the next reservation is within A hours; a step of calculating an estimate of the rental fee applied after the reservation cancellation is confirmed, when the number of cancellations having a large degree of influence after the addition is more than or equal to a threshold value; and a step of notifying the estimate.

This nonprovisional application is based on Japanese Patent Application No. 2017-234440 filed on Dec. 6, 2017, with the Japan Patent Office, the entire contents of which are hereby incorporated by reference.

### BACKGROUND

### Field

The present disclosure relates to a setting of a rental fee of an electric vehicle.

### Description of the Background Art

Conventionally, a rental system has been known in which an electric vehicle is rented to a user and a rental fee is collected therefrom. In such a rental system, when renting electric vehicles, a utilization ratio thereof is improved by allowing users to beforehand make reservations with regard to time periods during which the electric vehicles are to be used.

For example, Japanese Patent Laying-Open No. 2013-054537 discloses a technique for proposing utilization of a vehicle on a date and time on which there is room for reservations.

### SUMMARY

As described above, the utilization ratio of the electric vehicles can be improved by allowing the users to beforehand make reservations with regard to time periods during which the electric vehicles are to be used and by accepting the reservations.

However, if a user of users having made reservations cancels his/her reservation, a next reservation for a corresponding vehicle may be influenced depending on a timing of the reservation cancellation. For example, when a reservation is made such that a location at which an electric vehicle is to be rented is different from a location at which the electric vehicle is to be returned, if the reservation is canceled, the electric vehicle having been supposed to be moved to the return location will not be moved thereto. Accordingly, if another user has made a reservation with his/her renting location being the return location, the other user becomes unable to utilize the electric vehicle for which the foregoing reservation has been canceled, with the result that the utilization ratio cannot be improved. When a uniform rental fee is set for a user who has canceled reservations in this way a larges number of times and a user who has canceled reservations a smaller number of times, a highly satisfactory fee may be unable to be set for the user who has canceled reservations a smaller number of times, i.e., user who has contributed to improvement in the utilization ratio.

An object of the present disclosure is to provide a rental fee setting apparatus, a rental fee notification method, and a rental fee setting system, by each of which a rental fee highly satisfactory for users is set in consideration of a history of reservation cancellations when renting an electric vehicle.

A rental fee setting apparatus according to a certain aspect of the present disclosure is a rental fee setting apparatus for an electric vehicle in which a power storage device is mounted. The rental fee setting apparatus includes a setting device configured to set, based on reservation information and cancellation history information, a rental fee of the electric vehicle to be changeable according to the cancellation history information, the reservation information indicating that utilization of the electric vehicle per scheduled utilization period is reserved by a plurality of users, the cancellation history information indicating a history of reservation cancellations by each of the users. When a reservation cancellation is requested by the user, the setting device is configured to: set an estimate of the rental fee applied when the requested reservation cancellation is reflected in the cancellation history information; and notify the set estimate to the user.

In this way, since the user is notified of the estimate of the rental fee applied when the requested reservation cancellation is reflected in the cancellation history information, the user who requests the reservation cancellation can recognize the estimate of the rental fee applied when an electric vehicle is rented after the reservation cancellation is performed. Accordingly, the reservation cancellation can be deterred. Moreover, when the reservation is actually canceled, the rental fee is set using the cancellation history information, thereby eliminating unfairness between the user who cancels the reservation and a user who does not cancel a reservation. Accordingly, a rental fee highly satisfactory for users can be set.

In a certain embodiment, the cancellation history information includes information about the number of reservation cancellations having influences over next reservations, each of the reservation cancellations having the influences over the next reservations being a reservation cancellation such that a period from a time of the reservation cancellation to a scheduled time of start of utilization of the electric vehicle in a next reservation is shorter than a predetermined period. When the reservation cancellation is a reservation cancellation having an influence over a next reservation and when the number becomes larger than a threshold value if the requested reservation cancellation is performed, the setting device is configured to set the estimate to be more expensive than the estimate set when the number is smaller than the threshold value.

In this way, a user who cancels reservations having influences over next reservations a large number of times can recognize that the rental fee will be expensive when an electric vehicle is rented after the reservation cancellation is performed. Accordingly, the reservation cancellation can be deterred due to such a notification. Moreover, when the reservation is actually canceled, the rental fee becomes expensive, thereby eliminating unfairness between the user who cancels the reservation and a user who does not cancel a reservation. Accordingly, a rental fee highly satisfactory for users can be set.

In a certain embodiment, the rental fee setting apparatus further includes a reservation receiving device configured to receive a reservation for renting of the electric vehicle with a utilization start time being set as a time subsequent to a current time by a possible reservation period. When the reservation cancellation is a reservation cancellation having an influence over a next reservation and when the number becomes larger than the threshold value if the requested reservation cancellation is performed, the reservation receiving device is configured to set the possible reservation period to be shorter than the possible reservation period set when the number is smaller than the threshold value.

In this way, the reservation cancellation can be deterred and unfairness between the user who cancels the reservation and a user who do not cancel a reservation can be eliminated.

A rental fee notification method according to another aspect of the present disclosure is a method for notifying a rental fee of an electric vehicle in which a power storage device is mounted. The method includes: notifying, to each of the users, a rental fee of the electric vehicle corresponding to a reservation period of the user based on reservation information indicating that utilization of the electric vehicle per scheduled utilization period is reserved by a plurality of users; and notifying, to the user, a fee different from the rental fee in accordance with a history of reservation cancellations by the user when a reservation cancellation is requested by the user.

A rental fee setting system according to still another aspect of the present disclosure includes: an electric vehicle in which a power storage device is mounted; and a server configured to set a rental fee of the electric vehicle. Based on reservation information and cancellation history information, the server is configured to set the rental fee of the electric vehicle to be changeable according to the cancellation history information, the reservation information indicating that utilization of the electric vehicle per scheduled utilization period is reserved by a plurality of users, the cancellation history information indicating a history of reservation cancellations by each of the users. When a reservation cancellation is requested by the user, the server is configured to set an estimate of the rental fee applied when the requested reservation cancellation is reflected in the cancellation history information. The server is configured to notify the set estimate to the user.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an overall configuration diagram of a rental fee setting system according to the present embodiment.

FIG. 2 is a diagram showing an example of a configuration of an electric vehicle.

FIG. 3 is a diagram illustrating an example of a cancellation history list.

FIG. 4 is a flowchart showing a notification process for an estimate of a rental fee.

### DESCRIPTION OF THE PREFERRED EMBODIMENTS

The following describes embodiments of the present disclosure with reference to figures in detail. It should be noted that the same or corresponding portions in the figures are given the same reference characters and are not described repeatedly.

<As to Configuration of Rental Fee Setting System>

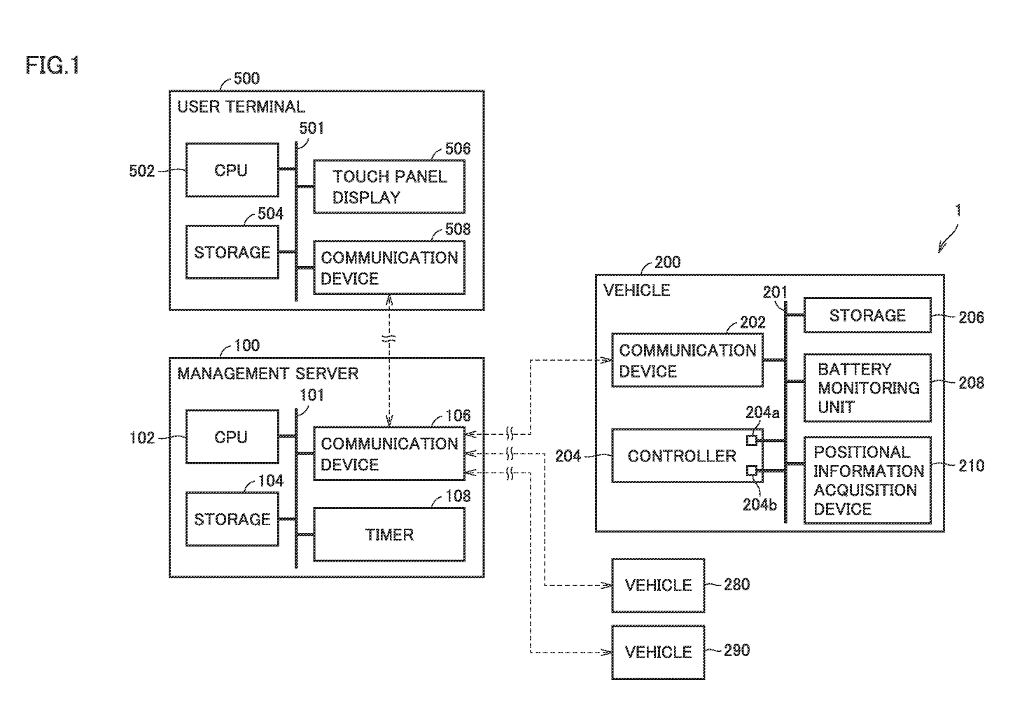

FIG. 1 is an overall configuration diagram of a rental fee setting system 1 according to the present embodiment. As shown in FIG. 1, rental fee setting system 1 according to the present embodiment includes: a management server 100; vehicles 200, 280, 290 that are electric vehicles; and a user terminal 500.

Management server 100 includes a CPU (Central Processing Unit) 101, a storage 104, a communication device 106, and a timer 108. Each component is communicatively connected by a communication bus 102.

CPU 102 is configured to execute predetermined computation processing based for example on information stored in storage 104, or information received from vehicle 200 or user terminal 500 via communication device 106.

Storage 104 includes, for example, a memory such as a ROM (Read Only Memory) and a RAM (Random Access Memory), and a large-capacity storage device such as a hard disk or a solid state drive. Storage 104 stores information (a user list, a reservation list, or a utilization history) for associating the plurality of vehicles 200, 280, 290 with respective users of the vehicles, for example.

Communication device 106 is configured to communicate with at least one of communication device 202 of vehicle 200 and communication device 508 of user terminal 500, for example. For example, communication device 106 and communication device 202 communicate information with each other through wireless communication. Communication device 106 and communication device 202 may communicate via a relay point (a wireless base station) or a predetermined communication network (for example, the Internet), or may not communicate via a relay point or a predetermined communication network. Further, communication device 106 is configured to similarly communicate with both vehicle 280 and vehicle 290.

The wireless communications may be done in a wireless communication system capable of transmitting and receiving signals via a relay point utilizing a wireless LAN (Local Area Network) represented by IEEE 802.11, a wireless communication standard for a mobile phone such as 2G, 3G, 4G, 5G, etc., and the like, or may be done in a wireless communication system capable of transmitting and receiving signals directly between communication device 106 and communication device 202 and for example utilizing a wireless communication standard such as Bluetooth (Registered trademark) or the like.

Communication between communication device 106 and communication device 508 is performed in a manner similar to the communication between communication device 106 and communication device 202. It should be noted that a communication system between communication device 106 and communication device 508 may be the same as or different from the communication system between communication device 106 and communication device 202. It should be noted that management server 100 is configured to communicate with a plurality of user terminals 500.

Timer 108 counts the current date and time. For example, CPU 102 stores in storage 104 a result of counting time by timer 108. When reading the current date and time from storage 104, CPU 102 may correct the current date and time by an externally received digital signal (standard radio wave) including date information and time information.

Vehicle 200 includes communication device 202, a controller 204, a storage 206, a battery monitoring unit 208, and a positional information acquisition device 210. Each component is communicatively connected by a communication bus 201.

Communication device 202 is configured to communicate with communication device 106 of management server 100, for example. Communication device 106 and communication device 202 wirelessly communicate as has been described above, and accordingly, how they do so will not be described redundantly.

Controller 204 includes, for example, a CPU 204a, a memory 204b (ROM and RAM), an input/output port for inputting and outputting various signals (not shown) and so forth. Controller 204 is configured to execute predetermined computation processing based on the information stored in memory 204b and storage 206, or information received from management server 100 via communication device 202.

Storage 206 is a storage device that can store data of a larger size than memory 204b, and is, for example, a storage device composed of a nonvolatile memory, a hard disk, a solid state drive, or the like. For example, storage 206 stores a driving history of vehicle 200 (for example, a history of positional information (i.e., traveling route)) or the like.

Battery monitoring unit 208 detects a state of a battery 214 mounted in vehicle 200. Battery monitoring unit 208 detects, for example, battery 214's voltage, current and temperature. Battery monitoring unit 208 calculates an estimated value of the SOC of battery 214 by using for example the detected voltage, current and temperature of battery 214. The SOC may be estimated using a well-known technique, and it will not be described specifically. Note that the SOC may be estimated by controller 204 rather than battery monitoring unit 208.

Positional information acquisition device 210 is configured to obtain the current position of vehicle 200. For example, positional information acquisition device 210 may obtain the current position of vehicle 200 by using GPS (Global Positioning System), or may obtain the current position of vehicle 200 by using positional information of a wireless communication device located outside vehicle 200 and capable of communicating with communication device 106. Positional information acquisition device 210 transmits to controller 204 a signal indicating the current position of vehicle 200 as obtained.

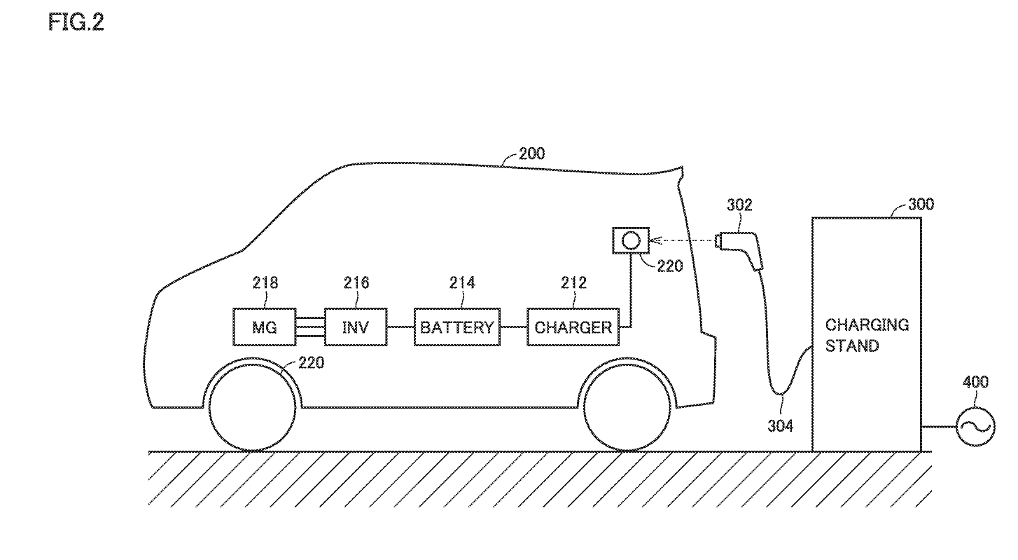

Vehicle 200 is an electric vehicle using an electric motor as a driving power source. FIG. 2 is a diagram showing an example of a configuration of an electric vehicle.

As shown in FIG. 2, vehicle 200 further includes a charger 212, battery 214, an inverter 216, a motor generator 218, and an inlet 220.

When a charging connector 302 of a charging stand 300 is attached to inlet 220, charger 212 charges battery 214 with power supplied from an external power supply 400.

Battery 214 is configured using, for example, a secondary battery such as a nickel metal hydride battery or a lithium ion battery. Battery 214 may be any power storage device capable of storing power, and for example, a large-capacity capacitor may be used instead of battery 214.

Inverter 216 is a power conversion device which converts power between AC power and DC power. Inverter 216 may for example convert DC power of battery 214 into AC power and supply it to motor generator 218. Further, inverter 216 may for example receive AC power (regenerative power) from motor generator 218, convert it into DC power, and supply it to battery 214 to electrically charge battery 214 therewith.

Motor generator 218 receives power supplied from inverter 216 and provides rotational force to a drive wheel 222. Drive wheel 222 is rotated by the rotational force provided by motor generator 218 to drive vehicle 200.

Inlet 220 is provided in vehicle 200 at an exterior portion of vehicle 200 together with a cover (not shown) such as a lid. Inlet 220 has a shape allowing charging connector 302 to be attached thereto. Inlet 220 and charging connector 302 both have contacts, respectively, incorporated therein, and when charging connector 302 is attached to inlet 220, the contacts come into contact with each other, and inlet 220 and charging connector 302 are thus electrically connected together.

Charging stand 300 is installed outside vehicle 200 and connected to charging connector 302 via a charging cable 304. Charging stand 300 is electrically connected to power supply 400, and when charging connector 302 is attached to inlet 220, the power of power supply 400 is supplied via charging stand 300, charging cable 304, and charging connector 302 to vehicle 200.

Vehicles 280 and 290 are similar in configuration to vehicle 200. Accordingly, they will not be described redundantly.

User terminal 500 includes a CPU 502, a storage 504, a touch panel display 506, and a communication device 508. Each component is communicatively connected by a communication bus 501.

CPU 502 is configured to execute predetermined computation processing based for example on information stored in storage 504, or information received from management server 100 via communication device 508. Storage 504 is constituted of a memory, such as ROM and RAM, for example.

Touch panel display 506 is constructed by providing a touch panel on a surface of a display screen of a liquid crystal display. Touch panel display 506 transmits, to CPU 502, an operation signal resulting from an operation performed onto the touch panel by the user. The liquid crystal display of touch panel display 506 presents an image based on a control signal from CPU 502. It should be noted that touch panel display 506 may be configured such that an input device such as a keyboard or a mouse and the display device such as the liquid crystal display may be provided separately.

Communication device 508 is configured to communicate with communication device 106 of management server 100, for example. Communication device 508 and communication device 106 wirelessly communicate as has been described above, and accordingly, how they do so will not be described redundantly.

For example, the user can use user terminal 500 to make a reservation to rent one of vehicles 200, 280, 290 during a period during which the user is to utilize the vehicle.

<As to Reservation Receiving Process>

User terminal 500 (specifically, CPU 502) creates reservation information in accordance with an operation of the user onto touch panel display 506, for example. User terminal 500 transmits the created reservation information to management server 100 via communication device 508.

Management server 100 receives the reservation information from user terminal 500. For example, the reservation information includes: information (user ID) for specifying the user; information (station ID) for specifying a station (site for renting an electric vehicle) serving as a departure location (i.e., a location at which the electric vehicle is to be rented); information for specifying a station serving as a return location (i.e., a location at which the electric vehicle is to be returned); date and time of start of utilization of the electric vehicle; and date and time of returning of the electric vehicle. When management server 100 receives the reservation information from user terminal 500, management server 100 updates the reservation list based on the reservation information. The reservation list includes: the information (user ID) for specifying the user; information (reservation ID) for specifying the reservation; the information (station ID) for specifying the station serving as the departure location; the information for specifying the station serving as the return location (destination); the date and time of start of utilization of the electric vehicle; the date and time of returning of the electric vehicle; and information (for example, numbers described in the license plate or the like) for specifying the vehicle to be rented. For example, management server 100 sets, as the vehicle to be rented, an electric vehicle that is parked at the station serving as the departure location and that has a battery having a SOC with which the vehicle at least can travel to the station serving as the return location. Management server 100 stores the updated reservation list into storage 104. Moreover, management server 100 transmits, to user terminal 500 via communication device 106, the information for specifying the vehicle to be rented, before the date and time of start of utilization thereof.

<As to Utilization Manner of Electric Vehicle>

In the present embodiment, as the utilization manner of the electric vehicle, for example, the user can select one of the following utilization manners: a utilization manner (lease) in which the electric vehicle is rented until a predetermined contract period (one year or a plurality of years) passes; a utilization manner (rental) in which a fee per unit time is set and a rental fee corresponding to a time of utilization is collected when returning the electric vehicle; and a utilization manner (sharing) in which a plurality of persons shares one electric vehicle or two or more electric vehicles until a predetermined contract period passes.

For example, when the electric vehicle is utilized in the rental type utilization manner of these utilization manners, a rental fee corresponding to the utilization may be set when returning vehicle 200. Alternatively, for example, when the electric vehicle is utilized in the lease type utilization manner, a leasing fee for each predetermined period (for example, one month) may be set. Alternatively, for example, when the electric vehicle is utilized in the sharing type utilization manner, a total of a fee for each predetermined period and a fee corresponding to the utilization may be set as a sharing fee.

When electric vehicles are rented in each of such utilization manners, the utilization ratio of the electric vehicles can be improved by allowing users to beforehand make reservations with regard to time periods during which the electric vehicles are to be used and by accepting the reservations.

However, if a user of users having made reservations cancels his/her reservation, utilization of a corresponding vehicle by a person who made the next reservation may be influenced depending on a timing thereof.

For example, when a reservation is made such that a location at which an electric vehicle is to be rented is different from a location at which the electric vehicle is to be returned, if the reservation is canceled, the electric vehicle having been supposed to be moved to the return location will not be moved thereto. Accordingly, if another user has made a reservation with his/her renting location being the return location, the other user becomes unable to utilize the electric vehicle for which the foregoing reservation has been canceled, with the result that the utilization ratio cannot be improved. When a uniform rental fee is set for a user who has canceled reservations in this way a larges number of times and a user who has canceled reservations a smaller number of times, a satisfactory fee may be unable to be set for the user who has canceled reservations a smaller number of times, i.e., user who has contributed to improvement in the utilization ratio.

To address this, in the present embodiment, based on reservation information and cancellation history information, management server 100 sets a rental fee of an electric vehicle to be changeable according to the cancellation history information. The reservation information indicates that utilization of the electric vehicle per scheduled utilization period is reserved by a plurality of users. The cancellation history information indicates a history of reservation cancellations by each of the users in past. When a reservation cancellation is requested by the user, management server 100 sets an estimate of the rental fee applied when the requested reservation cancellation is reflected in the cancellation history information, and management server 100 notifies the set estimate of the rental fee to the user.

In this way, since the user is notified of the estimate of the rental fee applied when the requested reservation cancellation is reflected in the cancellation history information, the user who requests the reservation cancellation can recognize the estimate of the rental fee applied when an electric vehicle is rented after the reservation cancellation is performed. Accordingly, the reservation cancellation can be deterred. Moreover, when the reservation is actually canceled, the rental fee is set using the cancellation history information, thereby eliminating unfairness between the user who cancels the reservation and a user who do not cancel a reservation. Accordingly, a rental fee highly satisfactory for users can be set. In the present embodiment, management server 100 corresponds to a “rental fee setting apparatus”.

<As to Exemplary Configuration of Cancellation History List>

For users in renting of electric vehicles, management server 100 associates a user ID for specifying a user with cancellation history information of the user, and stores them in storage 104 as a cancellation history list.

The cancellation history information includes: the total number of reservation cancellations; the number of reservation cancellations having a large degree of influence over the next reservations among the total number of reservation cancellations (hereinafter, referred to as “the number of cancellations having a large degree of influence”); the number of reservation cancellations having a medium degree of influence over the next reservations among the total number of reservation cancellations (hereinafter, referred to as “the number of cancellations having a medium degree of influence”); and the number of reservation cancellations having a small degree of influence over the next reservations among the total number of reservation cancellations (hereinafter, referred to as “the number of cancellations having a small degree of influence”). Moreover, the term “next reservation” means the most recent reservation after a canceled reservation with regard to a vehicle for which the reservation is canceled.

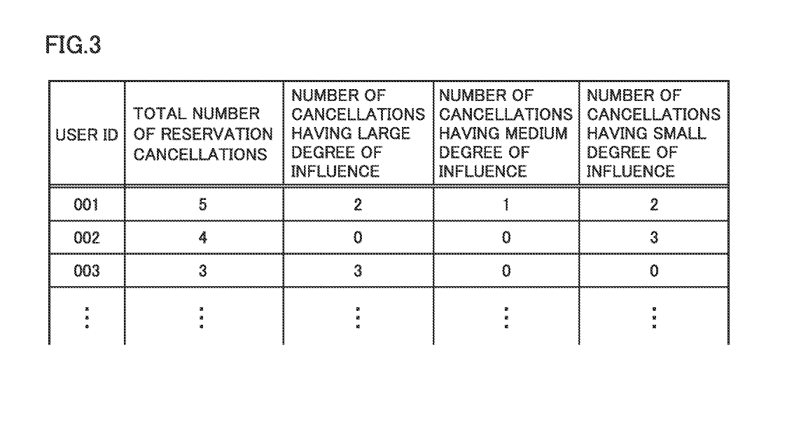

FIG. 3 shows an example of a configuration of the cancellation history list. As shown in FIG. 3, for example, in the cancellation history list, each of user IDs “001” to “003” is associated with the total number of reservation cancellations, the number of cancellations having a large degree of influence, the number of cancellations having a medium degree of influence, and the number of cancellations having a small degree of influence.

For example, the total number of reservation cancellations indicates the total number of reservation cancellations having been performed since registration of the user ID.

For example, the number of cancellations having a large degree of influence indicates the number of reservation cancellations such that a period from a time of each reservation cancellation to a time of start of utilization of the electric vehicle in the next reservation is within A hours.

For example, the number of cancellations having a medium degree of influence indicates the number of reservation cancellations such that a period from a time of each reservation cancellation to a time of start of utilization of the electric vehicle in the next reservation is longer than A hours and is within 1 day.

For example, the number of cancellations having a small degree of influence indicates the number of reservation cancellations such that a period from a time of each reservation cancellation to a time of start of utilization of the electric vehicle in the next reservation is longer than 1 day and is within 3 days.

<As to Calculation and Notification of Estimate of Rental Fee when Reservation Cancellation Request is Received>

For example, when management server 100 receives information indicating a request for reservation cancellation from user terminal 500, management server 100 makes reference to the cancellation history list stored in storage 104 to calculate an estimate of the rental fee applied when the requested reservation cancellation is confirmed, and transmits the calculated estimate to user terminal 500.

Specifically, when management server 100 receives the information indicating the request for reservation cancellation, management server 100 specifies the user and obtains the reservation information. Management server 100 determines whether the requested reservation cancellation corresponds to a cancellation having a large degree of influence, a cancellation having a medium degree of influence, or a cancellation having a small degree of influence. When the number of corresponding cancellations is increased, management server 100 calculates the estimate of the rental fee that is changed depending on whether the number of corresponding cancellations exceeds a threshold value. It should be noted that in the present embodiment, for example, it will be illustratively described that the rental fee is a rental fee per unit time in the rental type utilization manner.

<As to Notification Process for Estimate of Rental Fee>

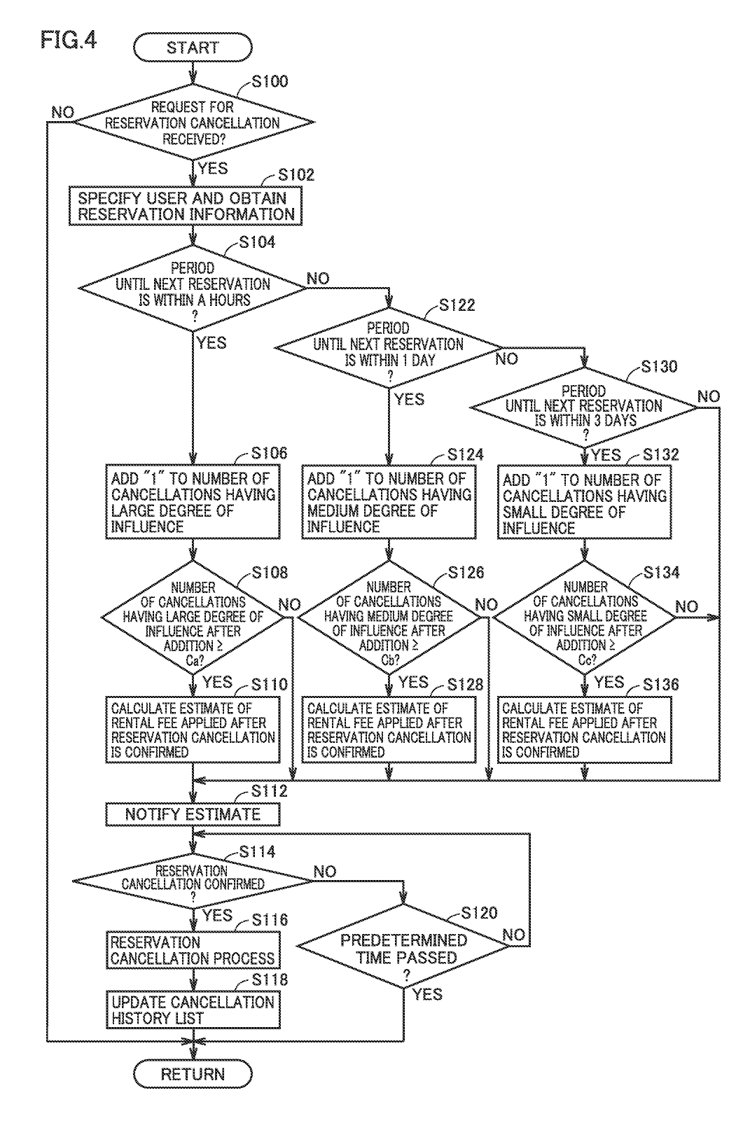

The following describes a notification process for the estimate of the rental fee in detail with reference to FIG. 4. FIG. 4 is a flowchart showing the notification process for the estimate of the rental fee. In the present embodiment, the notification process for the estimate of the rental fee will be described as being executed by management server 100 (more specifically, CPU 102 of management server 100) for the sake of illustration. While each step shown in the flowchart shown in FIG. 4 is implemented by software processing done by management server 100, a part thereof may be implemented by hardware (or electric circuitry) fabricated in management server 100. Regarding the below-described process, it may be illustratively described that a request for reservation cancellation is made from user terminal 500 to management server 100.

In a step (the term “step” will be hereinafter abbreviated as “S”) 100, management server 100 determines whether or not a request for reservation cancellation is received. For example, management server 100 determines that the request for reservation cancellation is received, when information indicating the request for reservation cancellation is received from user terminal 500 via communication device 106.

It should be noted that for example, when touch panel display 506 of user terminal 500 receives an operation for canceling a reservation (an operation of touching a reservation cancellation request button presented on a menu screen or the like), user terminal 500 transmits, to management server 100, information (user ID) for specifying the user, information for specifying the reservation (for example, a reservation ID or the like), and the information indicating the request for reservation cancellation. When it is determined that the request for reservation cancellation is received (YES in S100), the process proceeds to S102.

In S102, management server 100 specifies the user and obtains reservation information. For example, management server 100 specifies the user using the user ID received from user terminal 500, and obtains the reservation information from the reservation list using the reservation ID.

In S104, based on date and time (first date and time) on which the request for reservation cancellation is received, management server 100 determines whether or not a period until date and time (second date and time) of start of utilization of a vehicle in the next reservation is a period within A hours. When it is determined that the period from the first date and time to the second date and time is a period within A hours (YES in S104), the process proceeds to S106. It should be noted that the A hours are predetermined hours such as several hours, for example.

In S106, management server 100 adds “1” to the number of cancellations having a large degree of influence. In S108, management server 100 determines whether or not the number of cancellations having a large degree of influence after the addition is more than or equal to a threshold value Ca. Threshold value Ca is a predetermined value, for example. When it is determined that the number of cancellations having a large degree of influence after the addition is more than or equal to threshold value Ca (YES in S108), the process proceeds to S110. It should be noted that when the number of cancellations having a large degree of influence after the addition is less than threshold value Ca (NO in S108), the process proceeds to S112.

In S110, management server 100 calculates an estimate of the rental fee applied after the reservation cancellation is confirmed (assuming that the reservation cancellation is confirmed). When the number of cancellations having a large degree of influence after the addition is more than or equal to threshold value Ca, management server 100 does not apply all the discounts to the basic fee of the rental fee, and calculates a fee including a predetermined additional fee as the estimate of the rental fee applied after the reservation cancellation is confirmed.

It should be noted that examples of the discounts that may be applied to the basic fee include: a discount on condition of a long-term contract; a discount corresponding to a utilization time of the month; a discount corresponding to a utilization period from registration as a user; a discount corresponding to a return location; a discount corresponding to a utilization history of the vehicle upon returning the vehicle; and the like.

In S112, management server 100 notifies, to user terminal 500, the estimate of the rental fee applied after the reservation cancellation is confirmed. User terminal 500 presents, on touch panel display 506, the estimate of the rental fee received from management server 100 and applied when the reservation cancellation is confirmed. In this case, for the purpose of comparison, user terminal 500 may present, on touch panel display 506, both (i) the rental fee applied when the reservation cancellation is confirmed and (ii) the rental fee applied before the reservation cancellation. It should be noted that when no estimate is calculated, for example, because none of the processes of S110, S128, and S136 is performed, management server 100 may notify that the rental fee is not changed even if the reservation cancellation is confirmed this time.

In S114, management server 100 determines whether or not the reservation cancellation is confirmed. For example, when user terminal 500 receives, from management server 100, the notification of the estimate of the rental fee applied when the reservation cancellation is confirmed, user terminal 500 allows the user to select whether to confirm the reservation cancellation. When the user performs an operation for confirming the reservation cancellation (for example, an operation of touching a confirmation button presented on a display screen), user terminal 500 transmits, to management server 100, a signal indicating that the reservation cancellation is confirmed. When management server 100 receives, from user terminal 500, the signal indicating that the reservation cancellation is confirmed, management server 100 determines that the reservation cancellation is confirmed. When it is determined that the reservation cancellation is confirmed (YES in S114), the process proceeds to S116.

In S116, management server 100 performs the reservation cancellation process. Specifically, management server 100 deletes reservation information corresponding to the request for cancellation. Further, when the vehicle assigned to be rented for the reservation requested to be canceled is assigned to be rented in the next reservation at a location to which the vehicle has been supposed to be returned, management server 100 changes to another vehicle to be rented in the next reservation.

In S118, the management server updates the cancellation history list. Specifically, management server 100 updates the cancellation history list by adding “1” to the total number of reservation cancellations and adding “1” to one, which corresponds to the reservation cancellation, of the number of cancellations having a large degree of influence, the number of cancellations having a medium degree of influence, and the number of cancellations having a small degree of influence.

When it is determined that the reservation cancellation is not confirmed (NO in S114), the process proceeds to S120. In S120, management server 100 determines whether or not a predetermined time has passed since the estimate of the rental fee was notified. When it is determined that the predetermined time has passed since the estimate of the rental fee was notified (YES in S120), this process is ended. It should be noted that when it is determined that the predetermined time has not passed (NO in S120), the process is returned to S114.

It should be noted that when it is determined in S104 that the period until the next reservation (i.e., the period from the first date and time to the second date and time) is not a period within A hours (NO in S104), the process proceeds to S122.

In S122, management server 100 determines whether or not the period until the next reservation (i.e., period from the first date and time to the second date and time) is a period within 1 day. It should be noted that the period is not limited particularly to 1 day, and may be at least a period longer than A hours. When it is determined that the period until the next reservation is a period within 1 day (YES in S122), the process proceeds to S124.

In S124, management server 100 adds “1” to the number of cancellations having a medium degree of influence. In S126, management server 100 determines whether or not the number of cancellations having a medium degree of influence after the addition is more than or equal to a threshold value Cb. Threshold value Cb is a predetermined value, for example. When it is determined that the number of cancellations having a medium degree of influence after the addition is more than or equal to threshold value Cb (YES in S126), the process proceeds to S128. It should be noted that when the number of cancellations having a medium degree of influence after the addition is less than threshold value Cb (NO in S126), the process proceeds to S112.

In S128, management server 100 calculates an estimate of the rental fee applied after the reservation cancellation is confirmed (assuming that the reservation cancellation is confirmed). When the number of cancellations having a medium degree of influence after the addition is more than or equal to threshold value Cb, management server 100 calculates, as the estimate, a rental fee excluding all the discounts from the basic fee of the rental fee. The various types of discounts are mentioned above, and are not therefore described in detail repeatedly. It should be noted that for example, when the number of cancellations having a medium degree of influence is more than or equal to threshold value Cb, management server 100 at least calculates, as the estimate, a rental fee less expensive than the rental fee applied when the number of cancellations having a large degree of influence is more than or equal to threshold value Ca.

It should be noted that when it is determined in S122 that the period until the next reservation is not a period within 1 day (NO in S122), the process proceeds to S130.

In S130, management server 100 determines whether or not the period until the next reservation is within 3 days. It should be noted that the period is not limited particularly to 3 days, and may be at least a period longer than the period (1 day) for determining whether or not the number of cancellations is the number of cancellations having a medium degree of influence. When it is determined that the period until the next reservation is within 3 days (YES in S130), the process proceeds to S132.

In S132, management server 100 adds “1” to the number of cancellations having a small degree of influence. In S134, management server 100 determines whether or not the number of cancellations having a small degree of influence after the addition is more than or equal to a threshold value Cc. Threshold value Cc is a predetermined value, for example. When it is determined that the number of cancellations having a small degree of influence is more than or equal to threshold value Cc (YES in S134), the process proceeds to S136. It should be noted that when the number of cancellations having a small degree of influence after the addition is less than threshold value Cc (NO in S134), the process proceeds to S112.

In S136, management server 100 calculates an estimate of the rental fee applied after the reservation cancellation is confirmed (assuming that the reservation cancellation is confirmed). When the number of cancellations having a small degree of influence after the addition is more than or equal to threshold value Cc, management server 100 calculates, as the estimate, a rental fee excluding a part of the discounts from the basic fee of the rental fee. For example, the part of the discounts includes at least one of the following discounts: a discount on condition of a long-term contract; a discount corresponding to a utilization time of the month; a discount corresponding to a utilization period from registration as a user; a discount corresponding to a return location or a utilization history of the vehicle upon returning the vehicle; and the like. The various types of discounts are mentioned above, and are not therefore described in detail repeatedly.

It should be noted that when it is determined that no request for reservation cancellation is received (NO in S100), this process is ended. Moreover, when the period until the next reservation is a period longer than 3 days (NO in S130), the process proceeds to S112.

<As to Operation of Management Server 100 Serving as Rental Fee Setting Apparatus>

An operation of management server 100 which is a rental fee setting apparatus based on the above configuration and flowchart will now be described.

<Case where Period Until Next Reservation is Period within A Hours>

When the user performs, onto user terminal 500, an operation for requesting reservation cancellation, user terminal 500 transmits, to management server 100, information indicating the request for reservation cancellation. When management server 100 receives the information indicating the request for reservation cancellation (YES in S100), management server 100 specifies the user and obtains the reservation information (S102).

From the obtained reservation information and the reservation list, management server 100 obtains date and time of the next reservation for a corresponding vehicle. Management server 100 obtains a period from the time of receiving the request for reservation cancellation to the date and time of the next reservation. When this period is a period within A hours (YES in S104), management server 100 adds “1” to the number of cancellations having a large degree of influence (S106). When it is determined that the number of cancellations having a large degree of influence after the addition is more than or equal to threshold value Ca (YES in S108), the estimate of the rental fee applied after the reservation cancellation is confirmed is calculated (S110). Here, a rental fee excluding all the discounts and including an additional fee is calculated as the estimate. Management server 100 notifies the estimate to the user by transmitting the information about the calculated estimate to user terminal 500. When the user performs an operation for confirming the reservation cancellation, a signal indicating that the reservation cancellation is confirmed is transmitted from user terminal 500 to management server 100. When management server 100 receives the signal indicating that the reservation cancellation is confirmed (YES in S114), management server 100 performs the reservation cancellation process (S116) and updates the cancellation history list (S118).

On the other hand, when the user does not perform the operation for confirming the reservation cancellation (NO in S114), after passage of a predetermined period (NO in S120), the cancellation history list is not updated and the process is ended.

<Case where Period Until Next Reservation is Period Longer than A Hours and within 1 Day>

When the user performs, onto user terminal 500, an operation for requesting reservation cancellation, user terminal 500 transmits, to management server 100, information indicating the request for reservation cancellation. When management server 100 receives the information indicating the request for reservation cancellation (YES in S100), management server 100 specifies the user and obtains the reservation information (S102).

From the obtained reservation information and the reservation list, management server 100 obtains date and time of the next reservation for a corresponding vehicle. Management server 100 obtains a period from the time of receiving the request for reservation cancellation to the date and time of the next reservation. When this period is a period longer than A hours (NO in S104) and within 1 day (YES in S122), management server 100 adds “1” to the number of cancellations having a medium degree of influence (S124). When it is determined that the number of cancellations having a medium degree of influence after the addition is more than or equal to threshold value Cb (YES in S126), the estimate of the rental fee applied after the reservation cancellation is confirmed is calculated (S128). Here, a rental fee excluding all the discounts is calculated as the estimate. Management server 100 notifies the estimate to the user by transmitting the information about the calculated estimate to user terminal 500. When the user performs an operation for confirming the reservation cancellation, a signal indicating that the reservation cancellation is confirmed is transmitted from user terminal 500 to management server 100. When management server 100 receives the signal indicating that the reservation cancellation is confirmed (YES in S114), management server 100 performs the reservation cancellation process (S116) and updates the cancellation history list (S118).

<Case where Period Until Next Reservation is Period Longer than 1 Day and within 3 Days>

When the user performs, onto user terminal 500, an operation for requesting reservation cancellation, user terminal 500 transmits, to management server 100, information indicating the request for reservation cancellation. When management server 100 receives the information indicating the request for reservation cancellation (YES in S100), management server 100 specifies the user and obtains the reservation information (S102).

From the obtained reservation information and the reservation list, management server 100 obtains date and time of the next reservation for a corresponding vehicle. Management server 100 obtains a period from the time of receiving the request for reservation cancellation to the date and time of the next reservation. When this period is a period longer than 1 day (NO in S104 and NO in S122) and within 3 days (YES in S130), management server 100 adds “1” to the number of cancellations having a small degree of influence (S132). When it is determined that the number of cancellations having a small degree of influence after the addition is more than or equal to threshold value Cb (YES in S134), the estimate of the rental fee applied after the reservation cancellation is confirmed is calculated (S136). Here, a rental fee excluding a part of the discounts is calculated as the estimate. Management server 100 notifies the estimate to the user by transmitting information about the calculated estimate to user terminal 500. When the user performs an operation for confirming the reservation cancellation, a signal indicating that the reservation cancellation is confirmed is transmitted from user terminal 500 to management server 100. When management server 100 receives the signal indicating that the reservation cancellation is confirmed (YES in S114), management server 100 performs the reservation cancellation process (S116) and updates the cancellation history list (S118).

It should be noted that when the requested reservation cancellation is such a reservation cancellation that the period until the next reservation is a period longer than 3 days (NO in S130), it is notified that the rental fee is not changed (S112). When the reservation cancellation is confirmed (YES in S114), the reservation cancellation process is performed (S116) and the cancellation history list is updated. In this case, “1” is added only to the total number of reservation cancellations in the cancellation history list.

<As to Function and Effect by Rental Fee Setting Apparatus>

As described above, according to the rental fee setting apparatus according to the present embodiment, since the user is notified of the estimate of the rental fee applied when the requested reservation cancellation is reflected in the cancellation history information, the user who requests the reservation cancellation can recognize the estimate of the rental fee applied when an electric vehicle is rented after the reservation cancellation is performed. Accordingly, the reservation cancellation can be deterred. Moreover, when the reservation is actually canceled, the rental fee is set using the cancellation history list, thereby eliminating unfairness between the user who cancels the reservation and a user who does not cancel a reservation. Accordingly, a rental fee highly satisfactory for users can be set. Thus, there can be provided a rental fee setting apparatus, a rental fee notification method, and a rental fee setting system, by each of which a rental fee highly satisfactory for users is set in consideration of a history of reservation cancellations when renting an electric vehicle.

Further, a user who cancels reservations having influences over next reservations a large number of times can recognize that the rental fee will be expensive when an electric vehicle is rented after a reservation cancellation is performed. Accordingly, the reservation cancellation can be deterred due to such a notification. Moreover, when the reservation is actually canceled, the rental fee becomes expensive, thereby eliminating unfairness between the user who cancels the reservation and a user who does not cancel a reservation. Accordingly, a rental fee highly satisfactory for users can be set.

<As to Modifications>

In the above-described embodiment, it has been illustrated that when the requested reservation cancellation is a reservation cancellation having a large influence over the next reservation, the user is notified of the estimate of the rental fee changed according to the number of cancellations; however, in addition to the change of the rental fee, when the number of cancellations is more than a threshold value, a possible reservation period may be set to be shorter than that in the case where the number of cancellations is less than the threshold value. The possible reservation period refers to the maximum period in a period from the current time to a time until which utilization of an electric vehicle can be reserved. In this way, the reservation cancellation can be deterred and unfairness between a user who cancels a reservation and a user who do not cancel a reservation can be eliminated.

In the above-described embodiment, it has been described that the rental fee is changed to be more expensive as the number of reservation cancellations having a large degree of influence is larger; however, for example, in addition to changing the rental fee to be more expensive as the number of reservation cancellations having a large degree of influence is larger, no reservation may be permitted to be made, or even though a reservation may be permitted to be made, a reservation by another user may precede when the other user wishes to utilize an electric vehicle during a time period for which the foregoing reservation is made.

In the above-described embodiment, based on the period until the next reservation, it is determined whether the requested reservation cancellation corresponds to a cancellation having a large degree of influence, a cancellation having a medium degree of influence, or a cancellation having a small degree of influence; however, for example, even when the period until the next reservation is longer than A hours and is within 1 day, the requested reservation cancellation may be counted as a cancellation having a large degree of influence in the following cases: a case where the renting location is different from the return location; a case where the renting location is different from the return location and the number of rental electric vehicles parked in the return location is less than or equal to a threshold value; and a case where the magnitude of a difference between an estimated value of leaving time of the battery when the reservation is canceled and an estimated value of leaving time of the battery when the reservation is not canceled is more than or equal to a threshold value. Alternatively, even though the period until the next reservation is within A hours, the requested reservation cancellation may be counted as a cancellation having a small degree of influence, when the number of rental electric vehicles parked in the return location is more than the threshold value.

In the above-described embodiment, it has been described that the rental fee is changed when one of the number of cancellations having a large degree of influence, the number of cancellations having a medium degree of influence, and the number of cancellations having a small degree of influence is more than or equal to the threshold value; however, for example, the rental fee may be changed when a ratio of (i) one of the number of cancellations having a large degree of influence, the number of cancellations having a medium degree of influence, and the number of cancellations having a small degree of influence to (ii) the total number of reservation cancellations is more than or equal to a threshold value.

In the above-described embodiment, the rental fee per unit time has been described as an example of the rental fee; however, for example, a rental fee for each predetermined period (for example, 1 month) (that is, a monthly fee) may be employed.

It should be noted that the above modifications may be implemented all together or may partially be implemented in combination.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A rental fee setting apparatus for an electric vehicle in which a power storage device is mounted, the rental fee setting apparatus comprising:
a setting device configured to set, based on reservation information and cancellation history information, a rental fee of the electric vehicle to be changeable according to the cancellation history information, the reservation information indicating that utilization of the electric vehicle per scheduled utilization period is reserved by a plurality of users, the cancellation history information indicating a history of reservation cancellations by each of the users, wherein
when a reservation cancellation is requested by the user, the setting device is configured to
set an estimate of the rental fee applied when the requested reservation cancellation is reflected in the cancellation history information, and
notify the set estimate to the user.

2. The rental fee setting apparatus according to claim 1, wherein
the cancellation history information includes information about the number of reservation cancellations having influences over next reservations, each of the reservation cancellations having the influences over the next reservations being a reservation cancellation such that a period from a time of the reservation cancellation to a scheduled time of start of utilization of the electric vehicle in a next reservation is shorter than a predetermined period, and
when the reservation cancellation is a reservation cancellation having an influence over a next reservation and when the number becomes larger than a threshold value if the requested reservation cancellation is performed, the setting device is configured to set the estimate to be more expensive than the estimate set when the number is smaller than the threshold value.

3. The rental fee setting apparatus according to claim 2, further comprising a reservation receiving device configured to receive a reservation for renting of the electric vehicle with a utilization start time being set as a time subsequent to a current time by a possible reservation period, wherein
when the reservation cancellation is a reservation cancellation having an influence over a next reservation and when the number becomes larger than the threshold value if the requested reservation cancellation is performed, the reservation receiving device is configured to set the possible reservation period to be shorter than the possible reservation period set when the number is smaller than the threshold value.

4. A method for notifying a rental fee of an electric vehicle in which a power storage device is mounted, the method comprising:
notifying, to each of the users, a rental fee of the electric vehicle corresponding to a reservation period of the user based on reservation information indicating that utilization of the electric vehicle per scheduled utilization period is reserved by a plurality of users; and
notifying, to the user, a fee different from the rental fee in accordance with a history of reservation cancellations by the user when a reservation cancellation is requested by the user.

5. A rental fee setting system comprising:
an electric vehicle in which a power storage device is mounted; and
a server configured to set a rental fee of the electric vehicle, wherein
based on reservation information and cancellation history information, the server is configured to set the rental fee of the electric vehicle to be changeable according to the cancellation history information, the reservation information indicating that utilization of the electric vehicle per scheduled utilization period is reserved by a plurality of users, the cancellation history information indicating a history of reservation cancellations by each of the users,
when a reservation cancellation is requested by the user, the server is configured to set an estimate of the rental fee applied when the requested reservation cancellation is reflected in the cancellation history information, and
the server is configured to notify the set estimate to the user.
